(19) United States
(12) Patent Application Publication
(10) Pub. No.: US 2021/0130556 A1
(43) Pub. Date: May 6, 2021

(54) AEROGEL

(71) Applicant: INDUSTRY-ACADEMIC COOPERATION FOUNDATION, YONSEI UNIVERSITY, Seoul (KR)

(72) Inventors: Hyung-Ho PARK, Seoul (KR); Kyu-Yeon LEE, Seoul (KR); Hyunchul SOHN, Seoul (KR); Keonwook KANG, Seongnam-si (KR); Jinsung TAE, Seoul (KR)

(73) Assignee: INDUSTRY-ACADEMIC COOPERATION FOUNDATION, YONSEI UNIVERSITY, Seoul (KR)

(21) Appl. No.: 16/918,500

(22) Filed: Jul. 1, 2020

(30) Foreign Application Priority Data
Oct. 30, 2019 (KR) 10-2019-0136089

(51) Int. Cl. C08J 3/075; B01J 13/00; C08F 8/42; C08F 20/14; C08F 12/08; C08F 12/36; C08K 5/5419

(52) U.S. Cl. CPC C08J 3/075; B01J 13/0091; C08F 8/42; C08J 2325/14; C08F 12/08; C08F 12/36; C08K 5/5419; C08F 20/14

(57) ABSTRACT

An aerogel is provided. According to the inventive concept, the aerogel includes a first polymerization unit derived from a first monomer including an alkoxy silyl group; a second polymerization unit derived from a second monomer; and an inorganic aerogel which is chemically bonded to the first polymerization unit.

### CROSS-REFERENCE TO RELATED APPLICATIONS

This U.S. non-provisional patent application claims priority under 35 U.S.C. § 119 of Korean Patent Application No. 10-2019-0136089, filed on Oct. 30, 2019, the entire contents of which are hereby incorporated by reference.

### BACKGROUND

The present disclosure herein relates to an aerogel, and more particularly, to an organic-inorganic hybrid aerogel in which an organic aerogel is combined with an inorganic aerogel.

Nanoporous structures have a three-dimensional network structure in which plenty of pores are distributed and may have high specific surface area and low thermal conductivity due to high porosity. In addition, due to plenty of pores, low dielectric constant and low refractive index properties may be shown. Accordingly, the nanoporous structures may be usefully applied in many fields including insulation (super insulation) materials, soundproof materials, catalyst materials, supercapacitor materials, and electrode materials. As the nanoporous structure, an aerogel is used.

However, the issue of low mechanical strength has been raised for an inorganic aerogel. The issue of low melting point has been raised for an organic aerogel. Accordingly, though an aerogel has excellent physical properties and many application possibilities, the application thereof is still very scarce.

### SUMMARY

The task of the present disclosure is providing an aerogel having excellent properties.

The task for solving in the inventive concept is not limited to the above-described task, and unmentioned other tasks will be clearly understood by a person skilled in the art from the description below.

The present disclosure relates to an aerogel. According to the inventive concept, an aerogel may include a first polymerization unit derived from a first monomer including an alkoxy silyl group; a second polymerization unit derived from a second monomer; and an inorganic aerogel which is chemically bonded to the first polymerization unit.

In exemplary embodiments, the inorganic aerogel may be connected with the first polymerization unit by a covalent bond.

In exemplary embodiments, the covalent bond may be provided between carbon of the first polymerization unit and silicon of the inorganic aerogel.

In exemplary embodiments, the inorganic aerogel may be derived from an inorganic aerogel precursor, and the inorganic aerogel precursor may include an alkyl alkoxy silane compound of 4 to 12 carbon atoms.

In exemplary embodiments, the inorganic aerogel precursor may be represented by following Formula A:

(R₁)ₐ—Si—(OR₂)₄₋ₐ [Formula A]

in Formula A, R₁ and R₂ are each independently an alkyl group of 1 to 3 carbon atoms, and “a” is 1, 2, or 3.

In exemplary embodiments, the first polymerization unit may be represented by following Formula 1:

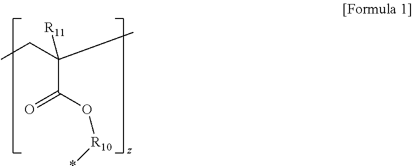

in Formula 1, R₁₀ is a substituted or unsubstituted alkyl group of 1 to 5 carbon atoms, R₁₁ is hydrogen, deuterium, or an alkyl group of 1 to 3 carbon atoms, * is a portion bonded to silicon (Si) of the inorganic aerogel, and “z” is an integer between 10 to 1000000.

In exemplary embodiments, the first monomer may be represented by following Formula 1A:

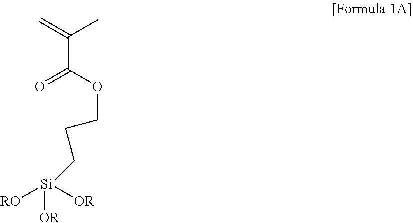

in Formula 1A, R is an alkyl group of 1 to 5 carbon atoms.

In exemplary embodiments, the second polymerization unit may be represented by following Formula 2:

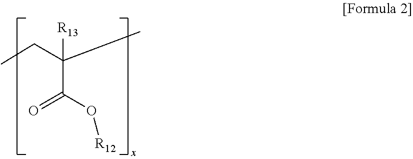

in Formula 2, R₁₂ is a linear or branched alkyl group of 5 to 10 carbon atoms, R₁₃ is hydrogen, deuterium, or an alkyl group of 1 to 3 carbon atoms, and “x” is an integer between 10 to 1000000.

In exemplary embodiments, the second monomer may be represented by following Formula 2A:

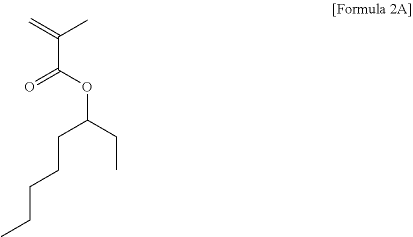

In exemplary embodiments, a third polymerization unit derived from a third monomer may be further included, and the third monomer may include a substituted or unsubstituted aromatic compound of 8 to 12 carbon atoms.

In exemplary embodiments, the third polymerization unit may be represented by following Formula 3:

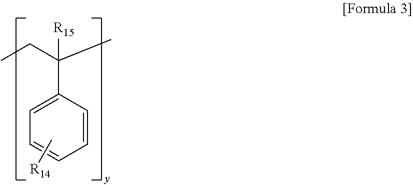

in Formula 3, R₁₄ and R₁₅ are each independently hydrogen, deuterium, or an alkyl group of 1 to 3 carbon atoms, and “y” may be an integer between 10 and 1000000.

In exemplary embodiments, the third monomer may be styrene.

In exemplary embodiments, a fourth polymerization unit derived from a fourth monomer may be further included, and the fourth monomer may include a substituted or unsubstituted aromatic compound of 10 to 14 carbon atoms.

In exemplary embodiments, the fourth monomer may be represented by following Formula 4A:

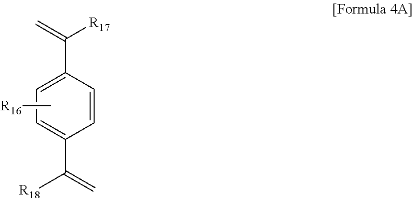

in Formula 4A, R₁₆, R₁₇, and R₁₈ are each independently hydrogen, deuterium, or an alkyl group of 1 to 3 carbon atoms.

In exemplary embodiments, the inorganic aerogel may be derived from methyltrimethoxysilane.

In exemplary embodiments, the aerogel may have a specific surface area of about 100 m²/g to about 1000 m²/g.

In exemplary embodiments, a contact angle of the aerogel may range from about 130 degrees to about 180 degrees.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a diagram schematically showing an aerogel according to embodiments.

FIG. 2 is a diagram showing the chemical structure of an aerogel according to an embodiment.

FIG. 3A shows Fourier-transform infrared spectrum analysis results on the intermediate products of Comparative Example, Experimental Example 1, Experimental Example 2, Experimental Example 3, Experimental Example 4, and Experimental Example 5.

FIG. 3B shows Fourier-transform infrared spectrum analysis results on the final products of Comparative Example, Experimental Example 1, Experimental Example 2, Experimental Example 3, Experimental Example 4, and Experimental Example 5.

### DETAILED DESCRIPTION

Hereinafter, preferred embodiments of the inventive concept will be described below with reference to the accompanying drawings for the sufficient understanding of the configuration and effects of the inventive concept. The inventive concept may, however, be embodied in various forms and many modifications should not be construed as limited to the embodiments set forth herein. Rather, these embodiments are provided so that this description will be thorough and complete, and will fully convey the scope of the present inventive concept to those skilled in the art. A person skilled in the art may understand that the inventive concept may be performed in any appropriate environments.

The terminology used herein is for the purpose of describing exemplary embodiments only and is not intended to limit the present inventive concept. As used herein, the singular forms are intended to include the plural forms as well, unless the context clearly indicates otherwise. It will be further understood that the terms “comprises” and/or “comprising,” when used in this specification, specify the presence of stated materials, configuration elements, steps, operations, and/or devices, but do not preclude the presence or addition of one or more other materials, configuration elements, steps, operations, and/or devices thereof.

In the disclosure, an alkyl group may be a linear alkyl group, a branched alkyl group, or a cyclic alkyl group. The carbon number of the alkyl group is not specifically limited, but may be an alkyl group of 1 to 15 carbon atoms may be used. Examples of the alkyl group may include a methyl group, an ethyl group, and a propyl group, without limitation.

In the disclosure, examples of a halogen may include fluorine (F), chlorine (Cl), bromine (Br), and iodine (I), without limitation.

In the disclosure, “substituted or unsubstituted” may mean substituted or unsubstituted with one or more substituents selected from the group consisting of a hydrogen atom, a deuterium atom, a halogen atom, an ether group, a halogenated alkyl group, a halogenated alkoxy group, a halogenated ether group, an alkyl group, and a hydrocarbon ring group. In addition, each of the exemplified substituents may be substituted or unsubstituted. For example, an alkyl ether group may be interpreted as an ether group.

In the disclosure, unless otherwise defined in chemical formulae, if a chemical bond is not drawn where the chemical bond is required to be drawn, it may mean a hydrogen atom is bonded at the position.

In the disclosure, the same reference number refers to the same configuration element throughout.

Hereinafter, an aerogel according to the inventive concept will be explained.

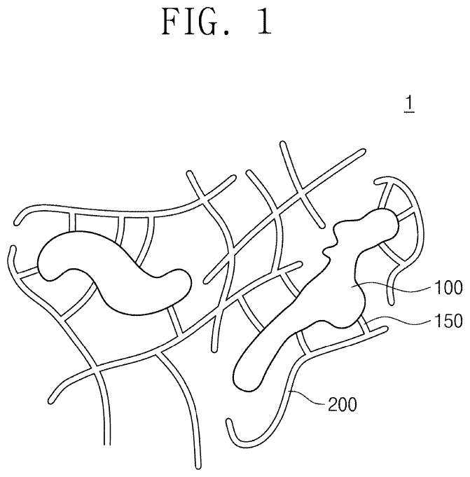

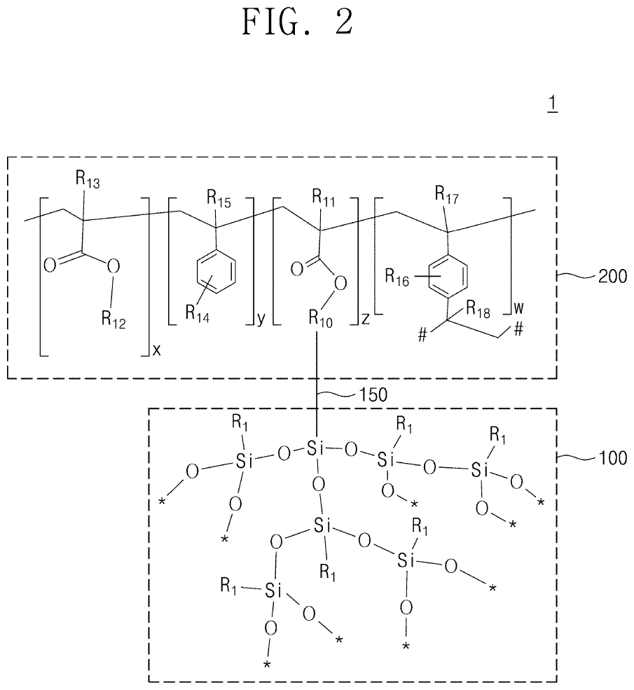

FIG. 1 is a diagram schematically showing an aerogel according to embodiments. FIG. 2 is a diagram showing the chemical structure of an aerogel according to an embodiment.

Referring to FIG. 1 and FIG. 2, an aerogel may be a hybrid aerogel 1. The hybrid aerogel 1 may include an inorganic aerogel 100 and an organic aerogel 200. The inorganic aerogel 100 may be connected with the organic aerogel 200 by a chemical bond 150. The chemical bond 150 between the organic aerogel 200 and the inorganic aerogel 100 may be, for example, a covalent bond. In an embodiment, the chemical bond 150 between the organic aerogel 200 and the inorganic aerogel 100 may be formed between the carbon (C) of the organic aerogel 200 and the silicon (Si) of the inorganic aerogel 100. The covalent bond may have a strong bonding force. Accordingly, the organic aerogel 200 may be strongly bonded to the inorganic aerogel 100.

Since the hybrid aerogel 1 includes the inorganic aerogel 100 and the organic aerogel 200, which are connected by the chemical bond 150, the hybrid aerogel 1 may have a low density, low thermal conductivity, hydrophobicity and high flexibility.

The hybrid aerogel 1 may have hydrophobicity and high porosity. The hybrid aerogel 1 may have a contact angle of about 130 degrees to about 180 degrees. In the disclosure, unless otherwise referred to, the contact angle may mean a water contact angle. According to an embodiment, the hybrid aerogel 1 may show super hydrophobicity. The super hydrophobicity may indicate that the contact angle is about 150 degrees or more. For example, the hybrid aerogel 1 may have a contact angle of about 150 degrees to about 180 degrees. Accordingly, the hybrid aerogel 1 may absorb a hydrophobic material. For example, the hybrid aerogel 1 may show improved oil-absorbing properties.

According to exemplary embodiment, the hybrid aerogel 1 has excellent flexibility, and in the case of a pressure is applied to the oil-absorbing hybrid aerogel 1, the hybrid aerogel 1 may release oil. The hybrid aerogel 1 may have excellent mechanical strength. For example, in the case of a high pressure is applied to the hybrid aerogel 1 and then, removed, the hybrid aerogel 1 may restore an original shape quickly. The original shape may mean a shape before applying the pressure. Accordingly, the hybrid aerogel 1 may be repeatedly used for absorbing oil.

According to exemplary embodiments, the hybrid aerogel 1 may have low thermal conductivity and thus, have insulation properties. The hybrid aerogel 1 may be light and may have small weight. Accordingly, the hybrid aerogel 1 may be readily applied to an insulating material for construction, etc.

Hereinafter, the chemical structure of the hybrid aerogel 1 according to exemplary embodiments will be explained.

The inorganic aerogel 100 may be derived from an inorganic aerogel precursor. The inorganic aerogel precursor may be a monomer. The inorganic aerogel precursor may include an alkyl alkoxy silane compound. The total carbon number of the alkyl alkoxy silane compound may be 4 to 12. For example, the inorganic aerogel 100 may be represented by following Formula A:

(R₁)ₐ—Si—(OR₂)₄₋ₐ [Formula A]

In Formula A, R₁ and R₂ are each independently an alkyl group of 1 to 3 carbon atoms, and “a” is 1, 2 or 3.

The precursor of the inorganic aerogel 100 may be represented by Formula A1 below. The inorganic aerogel precursor represented by Formula A1 may be methyltrimethoxysilane (hereinafter, MTMS).

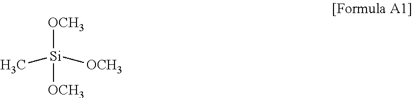

A plurality of inorganic aerogel precursors may be prepared, and the inorganic aerogel 100 may be synthesized by the reaction of the inorganic aerogel precursors (for example, by silanol condensation reaction). The alkoxy group (OR₂) of the inorganic aerogel precursor represented by the Formula A may participate in the reaction. The alkyl group (R₁) of the inorganic aerogel precursor represented by Formula A may not participate in the reaction. Accordingly, the inorganic aerogel 100 thus synthesized may include an alkyl group (R₁) bonded to a silicon element. The inorganic aerogel 100 may include the alkyl group (R₁) and may show hydrophobicity.

The organic aerogel 200 may include a first polymerization unit, a second polymerization unit, a third polymerization unit, and a fourth polymerization unit. At least two among the first polymerization unit, the second polymerization unit, the third polymerization unit, and the fourth polymerization unit may be connected from each other by a covalent bond. The first polymerization unit may be represented by following Formula 1:

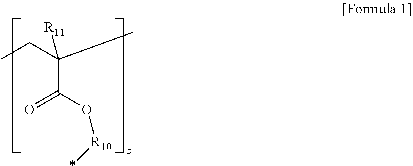

In Formula 1, R₁₀ is a substituted or unsubstituted alkyl group of 1 to 5 carbon atoms, R₁₁ is hydrogen, deuterium, or an alkyl group of 1 to 3 carbon atoms, * is a portion bonded to the silicon (Si) of the inorganic aerogel 100, and “z” may be an integer between 10 to 1000000.

The material represented by Formula 1 may be represented by following Formula 1-1:

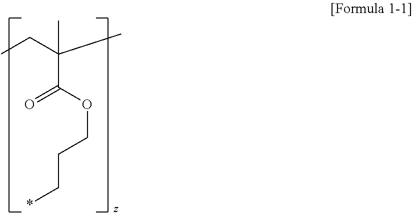

In Formula 1-1, “z” is an integer between 10 and 1000000, and * may be a portion bonding to the silicon of the inorganic aerogel 100.

The first polymerization unit may play the role of connecting the organic aerogel 200 and the inorganic aerogel 100. The first polymerization unit may be an interface reaction material. The first polymerization unit may be derived from a first monomer. The first monomer may be a first organic aerogel precursor. The first monomer may include an alkoxy silyl group. The alkoxy silyl group of the first monomer may react with the inorganic aerogel precursor. The first monomer may include, for example, an acrylate functional group. The polymerization reaction may take place at the acrylate functional group of the first monomer. For example, the acrylate functional group of the first monomer may undergo the polymerization reaction with at least one among the first monomer, and a second monomer, a third monomer and a fourth monomer, which will be explained later. The polymerization reaction may be radical polymerization reaction. The first monomer may be represented, for example, by following Formula 1A;

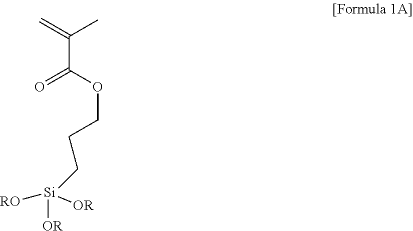

In Formula 1A, R may be an alkyl group of 1 to 5 carbon atoms.

In Formula 1A, for example, R may be a methyl group. That is, a material represented by Formula 1A may be 3-(trimethoxysilyl)propyl methacrylate (hereinafter, TPM).

The second polymerization unit may have a different structure from that of the first polymerization unit. The second polymerization unit may be represented by following Formula 2:

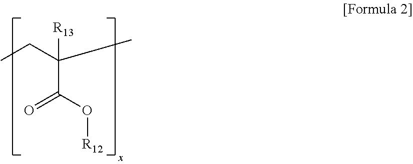

In Formula 2, R₁₂ is a linear or branched alkyl group of 5 to 10 carbon atoms, R₁₃ is hydrogen, deuterium, or an alkyl group of 1 to 3 carbon atoms, and “x” may be an integer between 10 to 1000000.

The second polymerization unit may be represented, for example, by following Formula 2-1:

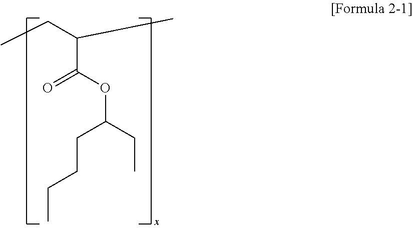

In Formula 2-1, “x” may be an integer between 10 and 1000000.

The second polymerization unit may be derived from a second monomer. The second monomer may be a second organic aerogel precursor. The second monomer may be represented by Formula 2A below. The second monomer represented by Formula 2A may be 2-ethylhexyl acrylate (hereinafter, EHA).

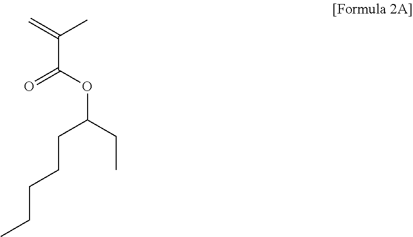

The second monomer may have a relatively low glass transition temperature. For example, the second monomer may have a glass transition temperature of about −70° C. to about −30° C. Since the hybrid aerogel 1 according to exemplary embodiments includes the second polymerization unit derived from the second monomer, a relatively low glass transition temperature may be achieved. Accordingly, the hybrid aerogel 1 may be flexible.

The third polymerization unit may include a substituted or unsubstituted aromatic compound of 8 to 12 carbon atoms. Since the third polymerization unit includes the aromatic ring compound, the third polymerization unit may be relatively stable. Since the hybrid aerogel 1 includes the third polymerization unit, the hybrid aerogel 1 may have high mechanical strength.

The third polymerization unit may be represented by following Formula 3:

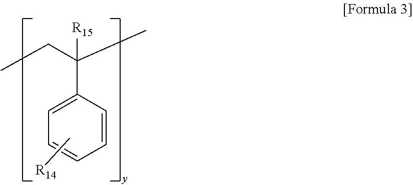

In Formula 3, R₁₄ and R₁₅ are each independently hydrogen, deuterium, or an alkyl group of 1 to 3 carbon atoms, and “y” may be an integer between 10 and 1000000.

The second polymerization unit may be represented, for example, by following Formula 3-1:

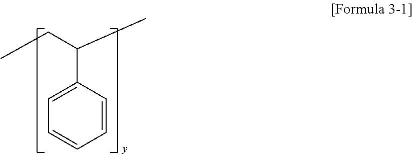

In Formula 3-1, “y” may be an integer between 10 and 1000000.

The third polymerization unit may be derived from a third monomer. The third monomer may be a third organic aerogel precursor. The third monomer may be represented by Formula 3A below. The third monomer represented by Formula 3A may be styrene.

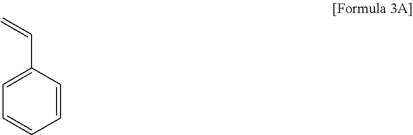

The fourth polymerization unit may include a substituted aromatic ring compound of 10 to 14 carbon atoms. Since the fourth polymerization unit includes the aromatic ring compound, the fourth polymerization unit may be relatively stable. Since the hybrid aerogel 1 includes the fourth polymerization unit, the hybrid aerogel 1 may have high mechanical strength. The fourth polymerization unit may be represented by following Formula 4:

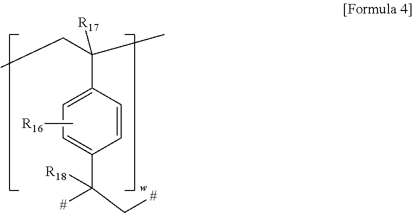

In Formula 4, R₁₆, R₁₇, and R₁₈ are each independently hydrogen, deuterium, or an alkyl group of 1 to 3 carbon atoms, “w” is an integer between 10 and 1000000, and # may be any one bonded portion to among the first polymerization unit to the fourth polymerization unit.

The fourth polymerization unit may be derived from a fourth monomer. The fourth monomer may be a fourth organic aerogel precursor. The fourth monomer may include a substituted or unsubstituted aromatic compound of 10 to 14 carbon atoms. For example, the fourth monomer may be an aromatic compound which is substituted with a divinyl group and has a total carbon number of 10 to 14. The fourth monomer may include a compound represented by following Formula 4A:

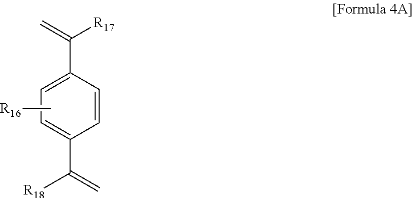

In Formula 4A, R₁₆, R₁₇, and R₁₈ are each independently hydrogen, deuterium, or an alkyl group of 1 to 3 carbon atoms.

The fourth monomer represented by Formula 4A may include a compound represented by Formula 4B below. The compound represented by Formula 4B may be divinylbenzene (hereinafter, DVB).

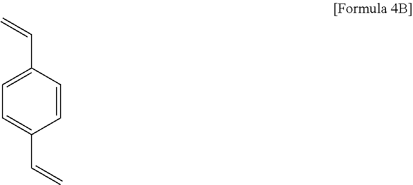

Since the fourth monomer includes divinyl, the fourth monomer may undergo polymerization reaction with two different monomers. The two different monomers may be any two among the first to fourth monomers. Accordingly, the fourth polymerization unit may play the role of a crosslinking binder.

The organic aerogel 200 may be represented by following Formula 5:

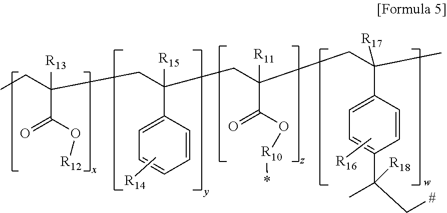

In Formula 5, R₁₀ is a substituted or unsubstituted alkyl group of 1 to 5 carbon atoms, R₁₁ is hydrogen, deuterium, or an alkyl group of 1 to 3 carbon atoms, R₁₂ is a linear or branched alkyl group of 5 to 10 carbon atoms, R₁₃, R₁₄, R₁₅, R₁₆, R₁₇, and R₁₈ are each independently hydrogen, deuterium, or an alkyl group of 1 to 3 carbon atoms, “x”, “y”, “z”, and “w” are each independently an integer between 10 and 1000000, * is a portion bonded to the silicon of the inorganic aerogel 100, and # may be a portion bonded to any one among the first polymerization unit to the fourth polymerization unit.

The organic aerogel 200 has voids, and the inorganic aerogel 100 may be provided in the voids of the organic aerogel 200. The average size of the voids of the inorganic aerogel 100 may be smaller than the average size of the voids of the organic aerogel 200. For example, the average diameter of the voids of the inorganic aerogel 100 may be smaller than the average diameter of the voids of the organic aerogel 200. The voids of the organic aerogel 200 may be macrovoids, and the inorganic aerogel 100 may be microporous.

Hereinafter, the method of preparing the hybrid aerogel 1 according to exemplary embodiments will be explained.

The preparation of the hybrid aerogel 1 may be performed by Reaction 1 as follows. Reaction 1 may be performed by a sol-gel process.

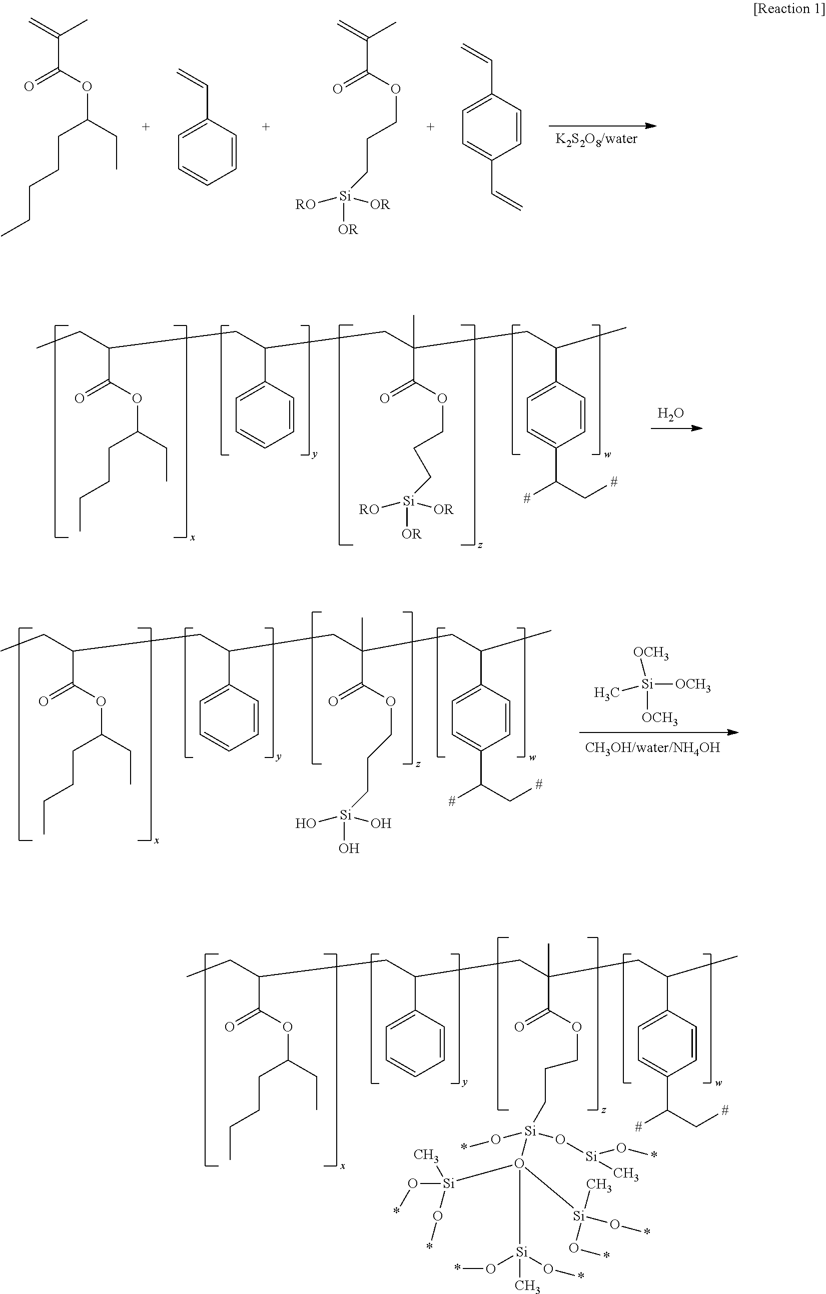

in Reaction 1, R is an alkyl group of 1 to 5 carbon atoms, “x”, “y”, “z”, and “w” are each independently an integer between 10 and 1000000, and * is a portion bonded to silicon.

After preparing the inorganic aerogel 100, if a surface treatment process using an organic material is performed on the inorganic aerogel 100, the interaction between the inorganic aerogel 100 and the organic material may be weak. The inorganic aerogel 100 may not be chemically bonded to the organic material. In addition, the uniform dispersion of the organic material in the inorganic aerogel 100 may be difficult.

According to exemplary embodiments, the hybrid aerogel 1 may be prepared by an in-situ process using an inorganic aerogel precursor, a first monomer, a second monomer, a third monomer, and a fourth monomer. Accordingly, the preparation process of the hybrid aerogel 1 may be simplified.

The first polymerization unit may play the role of a connecting medium between the organic aerogel 200 and the inorganic aerogel 100. For example, the alkoxy silanol group (SiOR) of the first monomer represented by Formula 1A above may react with the alkoxy silanol group (Si—OR₂) of the inorganic aerogel precursor represented by Formula A. By the reaction, a —Si—O—Si— bond is formed, and the inorganic aerogel 100 may be chemically boned to the organic aerogel 200. Specifically, the organic aerogel 200 may include a back bone and a silanol functional group connected with the back bone. The inorganic aerogel precursor may be chemically bonded to the silanol functional group of the organic aerogel 200.

Hereinafter, referring to the experimental examples of the inventive concept, the preparation of the hybrid aerogel and the evaluation of the properties thereof will be explained.

1. Preparation of Aerogel

Mixtures including TPM, EHA, styrene, and DVB in ratios shown in Table 1 below were prepared. The polymerization reaction of each mixture was performed. In this case, sorbitanmono-oleate (span 80) was used as a stabilizing agent. After finishing the polymerization reaction, MTMS was added to the mixture, and sol-gel reaction was performed. Thus, an aerogel was obtained. The polymerization reaction and the sol-gel reaction were performed as in Reaction 1 explained above.

MTMS, DVB, styrene, 2-ethylhexyl acrylate (EHA), 3-(trimethoxysilyl)propyl methacrylate (TPM), sorbitanmono-oleate (Span80), and potassium persulfate were purchased from Sigma Co.

Table 1 shows the kind and weight of reactants used for preparing the aerogels of Comparative Example, Experimental Example 1, Experimental Example 2, Experimental Example 3, Experimental Example 4, and Experimental Example 5.

TABLE 1

| | Kind and weight of reactants | | | |
|---|---|---|---|---|
| | Styrene (g) | DVB (g) | EHA (g) | TPM (g) |
| Comparative Example | 1.0 | 1.25 | 3.54 | 0 |
| Experimental Example | 1.0 | 1.45 | 3.54 | 1.19 |
| 1, TPM1 | | | | |
| Experimental Example | 1.0 | 1.66 | 3.54 | 2.38 |
| 2, TPM2 | | | | |
| Experimental Example | 1.0 | 1.87 | 3.54 | 3.57 |
| 3, TPM3 | | | | |
| Experimental Example | 1.0 | 2.08 | 3.54 | 4.76 |
| 4, TPM4 | | | | |
| Experimental Example | 1.0 | 2.50 | 3.54 | 7.15 |
| 5, TPM5 | | | | |

DVB: divinylbenzene
EHA: 2-ethylhexyl acrylate
TPM: 3-(trimethoxysilyl)propyl methacrylate

2. Analysis of Aerogel Prepared

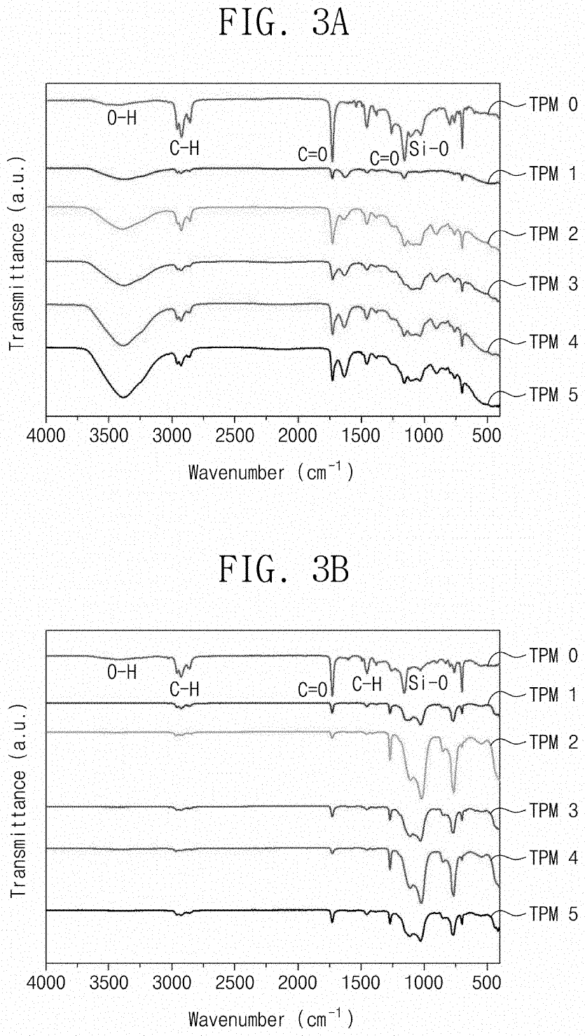

FIG. 3A shows Fourier-transform infrared spectrum analysis results on the intermediate products of Comparative Example, Experimental Example 1, Experimental Example 2, Experimental Example 3, Experimental Example 4, and Experimental Example 5. The intermediate products are obtained after performing polymerization reaction using TPM, EHA, styrene, and DVB and before adding methyltrimethoxysilane (MTMS). In FIG. 3A, TPM0, TPM1, TPM2, TPM3, TPM4, and TPM5 correspond to analysis results of Comparative Example, Experimental Example 1, Experimental Example 2, Experimental Example 3, Experimental Example 4, and Experimental Example 5, respectively.

Referring to FIG. 3A, the peak intensity at a wavelength of 3450 cm⁻¹ increases in order for Experimental Example 5, Experimental Example 4, Experimental Example 3, Experimental Example 2, Experimental Example 1, and Comparative Example. The peak at a wavelength of 3450 cm⁻¹ may correspond to an OH bond. It could be found that as the amount of TPM in the aerogel increases, the OH bond in the aerogel increases. Referring to Reaction 1, the OH bond may be produced by the hydration of the methoxy silyl group of a polymerization unit derived from TPM.

The peak at a wavelength of 1080 cm⁻¹ corresponds to the peak of a Si—O—Si bond. It could be found that though Comparative Example does not have the Si—O—Si bond, the hybrid aerogels of Experimental Example 1, Experimental Example 2, Experimental Example 3, Experimental Example 4, and Experimental Example 5 have the Si—O—Si bond. The peaks at wavelengths of 1155 cm⁻¹ and 1730 cm⁻¹ correspond to the peaks of a carbonyl group. The peak at 2925 cm⁻¹ corresponds to the peak of a C—H bond.

FIG. 3B shows Fourier-transform infrared spectrum analysis results on the final products of Comparative Example, Experimental Example 1, Experimental Example 2, Experimental Example 3, Experimental Example 4, and Experimental Example 5. The final products are formed after adding MTMS. In FIG. 3B, TPM0, TPM1, TPM2, TPM3, TPM4, and TPM5 correspond to analysis results of Comparative Example, Experimental Example 1, Experimental Example 2, Experimental Example 3, Experimental Example 4, and Experimental Example 5, respectively.

Referring to FIG. 3B, the peak at 3450 cm⁻¹ was observed in Comparative Example, but the peak at 3450 cm⁻¹ was not observed in Experimental Example 1, Experimental Example 2, Experimental Example 3, Experimental Example 4, and Experimental Example 5. When compared with the results of the intermediate products shown in FIG. 3A, it could be found that the peak at 3450 cm⁻¹ disappeared in Experimental Example 1, Experimental Example 2, Experimental Example 3, Experimental Example 4, and Experimental Example 5. Referring to Reaction 1, it could be found that OH formed at the polymerization unit derived from TPM and the functional group at the terminal of MTMS were condensed, and the OH bond disappeared. The functional group at the terminal of MTMS may include an alkoxy silane group such as methoxy silane (—Si—OCH₃). Accordingly, it could be found that the inorganic aerogel and the organic aerogel make a covalent bond.

In cases of Experimental Example 1, Experimental Example 2, Experimental Example 3, Experimental Example 4, and Experimental Example 5, when compared with the results of the intermediate products of FIG. 3A, very strong peaks at 1089 cm⁻¹ were found for the final products shown in FIG. 3B. The peak at 1089 cm⁻¹ corresponds to the peak of a Si—O—Si bond. From the results, it could be found that the organic aerogel was formed by the polymerization reaction of the first to fourth monomers, a hydrated MTMS sol undergone gelation, and the inorganic aerogel was formed.

The peak intensity at wavelengths of 1450 cm⁻¹ and 2900 cm⁻¹ was increased in order for Comparative Example, Experimental Example 1, Experimental Example 2, Experimental Example 3, Experimental Example 4, and Experimental Example 5. From the results, it could be found that as the amount of TPM increases, the amount of a methyl group in the hybrid aerogel increases. The methyl group may be hydrophobic. That is, it could be found that as the amount of TPM increases, the hydrophobicity of the hybrid aerogel increases. The methyl group may correspond to a group represented by OR₁ in FIG. 2.

3. Evaluation of Aerogel Properties

[Evaluation of Physical Properties]

Table 2 shows evaluation results of the density, thermal conductivity, contact angle, specific surface area, and flexible properties of the final products of Comparative Example, Experimental Example 1, Experimental Example 2, Experimental Example 3, Experimental Example 4, and Experimental Example 5.

TABLE 2

| | | | Water | BET | |
|---|---|---|---|---|---|
| | | Thermal | contact | surface | |
| | Density | conductivity | angle | area | Flexible |
| | (g/cm³) | (W/m · K) | (degree) | (m²/g) | properties |
| Comparative | 0.120 | 0.1084 | 0 | 12 | Very |
| Example | | | | | flexible |
| Experimental | 0.128 | 0.0450 | 160 | 115 | Flexible |
| Example 1 | | | | | |
| Experimental | 0.130 | 0.0442 | 162 | 270 | Slightly |
| Example 2 | | | | | flexible |
| Experimental | 0.136 | 0.0455 | 163 | 350 | Hard |
| Example 3 | | | | | |
| Experimental | 0.139 | 0.0471 | 163 | 401 | Not form |
| Example 4 | | | | | monolith |
| Experimental | 0.142 | 0.0492 | 165 | 468 | Powder type |
| Example 5 | | | | | |

Referring to Table 2, the final products of Experimental Example 1, Experimental Example 2, Experimental Example 3, Experimental Example 4, and Experimental Example 5 have a density of about 0.120 g/cm³ or more, particularly, about 0.125 g/cm³ to about 0.150 g/cm³. The above-described density range corresponds to the density range of the hybrid aerogel. Accordingly, from the density range measured, it could be confirmed that the final products of Experimental Example 1, Experimental Example 2, Experimental Example 3, Experimental Example 4, and Experimental Example 5 are hybrid aerogels.

The hybrid aerogels of Experimental Example 1, Experimental Example 2, Experimental Example 3, Experimental Example 4, and Experimental Example 5 have smaller thermal conductivity than the aerogel of Comparative Example. For example, the hybrid aerogels of Experimental Example 1, Experimental Example 2, Experimental Example 3, Experimental Example 4, and Experimental Example 5 have thermal conductivity of about 0.0001 W/m-K to about 1.0000 W/m-K. The hybrid aerogels of Experimental Example 1, Experimental Example 2, Experimental Example 3, Experimental Example 4, and Experimental Example 5 may show high insulation properties.

The hybrid aerogels of Experimental Example 1, Experimental Example 2, Experimental Example 3, Experimental Example 4, and Experimental Example 5 have very large contact angles than the aerogel of Comparative Example. The hybrid aerogels of Experimental Example 1 to Experimental Example 5 have contact angles of about 130 degrees to about 180 degrees. It could be confirmed that the hybrid aerogels of Experimental Example 1 to Experimental Example 5 are hydrophobic, but the aerogel of Comparative Example is hydrophilic. Particularly, it could be found that the hybrid aerogels of Experimental Example 1 to Experimental Example 5 may show super hydrophobicity.

The hybrid aerogels of Experimental Example 1 and Experimental Example 2 were observed to have flexible properties.

The hybrid aerogels of Experimental Example 1 to Experimental Example 5 have very large specific surface areas when compared with a specific surface area of the aerogel of Comparative Example. Particularly, the specific surface areas of the hybrid aerogels of Experimental Example 1, Experimental Example 2, Experimental Example 3, Experimental Example 4 and Experimental Example 5 are 10 or more times greater than the specific surface area of the aerogel of Comparative Example. The specific surface areas of the hybrid aerogels of Experimental Example 1, Experimental Example 2, Experimental Example 3, Experimental Example 4 and Experimental Example 5 were measured as about 100 m²/g to about 1000 m²/g. As the amount of the inorganic aerogel precursor (for example, TPM) increases, the specific surface area of the hybrid aerogel increases. Since the inorganic aerogel (for example, silica network) has a mesoporous structure, it could be found that the specific surface area of the hybrid aerogel increases as the amount of the inorganic aerogel (for example, silica network) in the hybrid aerogel increases.

[Evaluation of Surface Morphology Properties]

The surface morphology properties were observed using a scanning electron microscope (SEM) and a micrograph.

(1) Observation Results of Intermediate Product Before Adding MTMS

The intermediate product before adding MTMS corresponds to a polymerization by high internal phase emulsion (polyHIPE). The polyHIPE may be similar to the above-explained organic aerogel. It was observed that Comparative Example, Experimental Example 1, Experimental Example 2, Experimental Example 3, Experimental Example 4 and Experimental Example 5 had open-cellular morphologies with macroporous voids. In cases of Comparative Example, Experimental Example 1, Experimental Example 2, Experimental Example 3, Experimental Example 4 and Experimental Example 5, it was observed that voids in the polyHIPE were interconnected.

(2) Observation Results of Final Product after Adding MTMS

In case of Comparative Example, it was observed that voids in the polyHIPE were empty. It was observed that voids in the polyHIPE had spherical voids of about 15 m or less.

In cases of Experimental Example 1, Experimental Example 2, Experimental Example 3, Experimental Example 4 and Experimental Example 5, it was observed that the inorganic aerogel (for example, silica aerogel) was formed in the organic aerogel (for example, polyHIPE). In this case, the polyHIPE has the network of a micro size. The silica aerogel has smaller pores than the organic aerogel. It was observed that the polyHIPE of Experimental Example 1 to Experimental Example 5 had polyhedral voids. The void structure of the organic aerogels of the final products of Experimental Example 1 to Experimental Example 5 is different from the void structure of the organic aerogel of the intermediate product. This is considered because the functional groups of silica nanoparticles and the polyHIPE interact during the forming process of the silica aerogel.

[Thermogravimetry]

A sample was put in a chamber. While elevating the temperature in the chamber, the weight loss of the sample was measured. Thermogravimetry experiment was conducted using each sample of Comparative Example, Experimental Example 1, Experimental Example 2, Experimental Example 3, Experimental Example 4 and Experimental Example 5.

Table 3 shows the thermogravimetry analysis results of the final products of Comparative Example, Experimental Example 1, Experimental Example 2, Experimental Example 3, Experimental Example 4 and Experimental Example 5.

TABLE 3

| | Remaining sample of a sample |
|---|---|
| | after thermogravimetry (%) |
| Comparative Example | 2 |
| Experimental Example 1 | 10 |
| Experimental Example 2 | 14 |
| Experimental Example 3 | 16 |
| Experimental Example 4 | 18 |
| Experimental Example 5 | 41 |

Referring to Table 3, the weight of the sample increased in order for Comparative Example, Experimental Example 1, Experimental Example 2, Experimental Example 3, Experimental Example 4 and Experimental Example 5. Generally, in case of the silica aerogel and polyHIPE, weight loss is generated from about 280° C. The weight losses of Experimental Example 1, Experimental Example 2, Experimental Example 3, Experimental Example 4 and Experimental Example 5 were started from about 307° C. and maintained to about 464° C. The weight loss at the temperature could be generated due to the decomposition of organic materials. In cases of Experimental Example 1, Experimental Example 2, Experimental Example 3, Experimental Example 4 and Experimental Example 5, silica is covalently bonded to the polyHIPE, and thermal stability could be confirmed until about 307° C. in the air.

[Evaluation of Oil Absorption and Recovery Properties]

1 g of a sample is added to a mixture of crude oil and water, and the weight of oil absorbed is measured. A pressure is applied to an oil-absorbing aerogel, and the weight of the oil released is measured. The absorption and release of the oil may comprise one cycle. The absorption and release of the oil is repeated for 2 to 25 cycles, and the weight of oil absorbed is measured according to the cycle. The absorption and desorption properties of the oil are evaluated using each of the samples of Comparative Example, Experimental Example 1, Experimental Example 2, Experimental Example 3, Experimental Example 4 and Experimental Example 5.

Table 4 shows the weight of oil absorbed by 1 g of a sample.

TABLE 4

| | Weight of oil absorbed by 1 g of sample |
|---|---|
| Comparative Example | — |
| Experimental Example 1 | 18 g |
| Experimental Example 2 | 18 g |
| Experimental Example 3 | 20 g |
| Experimental Example 4 | 21 g |
| Experimental Example 5 | 24 g |

Referring to Table 4, it could be observed that the hybrid aerogels of Experimental Example 1, Experimental Example 2, Experimental Example 3, Experimental Example 4 and Experimental Example 5 absorb a large amount of oil. It was observed that if a pressure was applied to Experimental Example 1 wherein the oil was absorbed, 16 g of oil was released. In cases of Experimental Example 1, Experimental Example 2, Experimental Example 3, Experimental Example 4 and Experimental Example 5, it was observed that the amount of oil absorbed in the hybrid aerogel at the 25th cycle was substantially the same as the amount of aerogel absorbed at the first cycle. In addition, in cases of Experimental Example 1, Experimental Example 2, Experimental Example 3, Experimental Example 4 and Experimental Example 5, it was observed that the amount of oil released from the hybrid aerogel at the 25th cycle was substantially the same as the amount of aerogel released at the first cycle.

It was confirmed that Experimental Example 1 had excellent absorption and desorption properties with respect to various organic materials such as pentane, hexane, heptane, octane, toluene, methanol, ethanol, petrol and crude oil as well as oil.

According to the inventive concept, the hybrid aerogel may include an inorganic aerogel and an organic aerogel. The inorganic aerogel may be connected with the organic aerogel by a chemical bond. The hybrid aerogel may have low thermal conductivity, hydrophobicity, a large surface area, excellent mechanical strength, and excellent flexibility.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An aerogel, comprising:
a first polymerization unit derived from a first monomer comprising an alkoxy silyl group;
a second polymerization unit derived from a second monomer; and
an inorganic aerogel which is chemically bonded to the first polymerization unit.

2. The aerogel of claim 1, wherein the inorganic aerogel is connected with the first polymerization unit by a covalent bond.

3. The aerogel of claim 2, wherein the covalent bond is provided between carbon of the first polymerization unit and silicon of the inorganic aerogel.

4. The aerogel of claim 1, wherein the inorganic aerogel is derived from an inorganic aerogel precursor, and
the inorganic aerogel precursor comprises an alkyl alkoxy silane compound of 4 to 12 carbon atoms.

5. The aerogel of claim 4, wherein the inorganic aerogel precursor is represented by following Formula A:
(R₁)ₐ—Si—(OR₂)₄₋ₐ [Formula A]
in Formula A, R₁ and R₂ are each independently an alkyl group of 1 to 3 carbon atoms, and “a” is 1, 2, or 3.

6. The aerogel of claim 1, wherein the first polymerization unit is represented by following Formula 1: 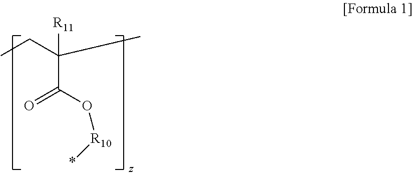
in Formula 1, R₁₀ is a substituted or unsubstituted alkyl group of 1 to 5 carbon atoms, R₁₁ is hydrogen, deuterium, or an alkyl group of 1 to 3 carbon atoms, * is a portion bonded to silicon (Si) of the inorganic aerogel, and “z” is an integer between 10 to 1000000.

7. The aerogel of claim 1, wherein the first monomer is represented by following Formula 1A: 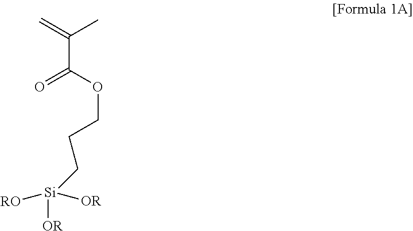
in Formula 1A, R is an alkyl group of 1 to 5 carbon atoms.

8. The aerogel of claim 1, wherein the second polymerization unit is represented by following Formula 2: 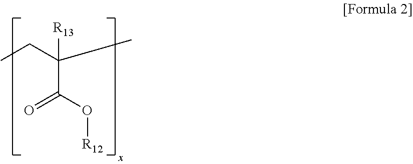
in Formula 2, R₁₂ is a linear or branched alkyl group of 5 to 10 carbon atoms, R₁₃ is hydrogen, deuterium, or an alkyl group of 1 to 3 carbon atoms, and “x” is an integer between 10 to 1000000.

9. The aerogel of claim 1, wherein the second monomer is represented by following Formula 2A:

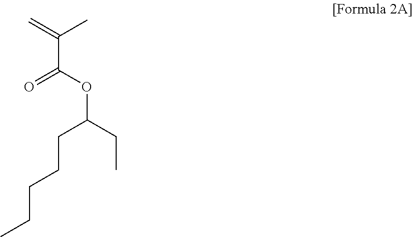

10. The aerogel of claim 1, further comprising a third polymerization unit derived from a third monomer,
wherein the third monomer comprises a substituted or unsubstituted aromatic compound of 8 to 12 carbon atoms.

11. The aerogel of claim 10, wherein the third polymerization unit is represented by following Formula 3: 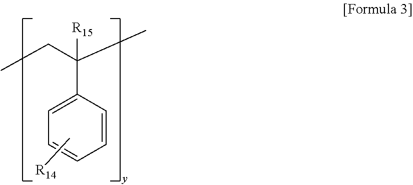
in Formula 3, R₁₄ and R₁₅ are each independently hydrogen, deuterium, or an alkyl group of 1 to 3 carbon atoms, and “y” is an integer between 10 and 1000000.

12. The aerogel of claim 10, wherein the third monomer is styrene.

13. The aerogel of claim 1, further comprising a fourth polymerization unit derived from a fourth monomer,
wherein the fourth monomer comprises a substituted or unsubstituted aromatic compound of 10 to 14 carbon atoms.

14. The aerogel of claim 13, wherein the fourth monomer is represented by following Formula 4A: 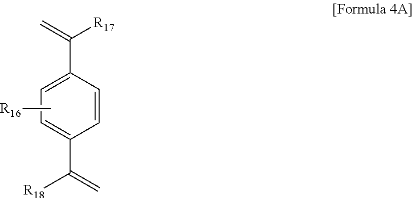
in Formula 4A, R₁₆, R₁₇, and R₁₈ are each independently hydrogen, deuterium, or an alkyl group of 1 to 3 carbon atoms.

15. The aerogel of claim 1, wherein the inorganic aerogel is derived from methyltrimethoxysilane.

16. The aerogel of claim 1, a specific surface area of the aerogel ranges from about 100 m²/g to about 1000 m²/g.

17. The aerogel of claim 1, a contact angle of the aerogel ranges from about 130 degrees to about 180 degrees.
